(19) United States
(12) Patent Application Publication
(10) Pub. No.: US 2015/0108170 A1
(43) Pub. Date: Apr. 23, 2015

(54) DEVICE FOR DISPENSING LIQUID WITH HIGH PRECISION

(71) Applicant: Yibing Li, San Francisco, CA (US)

(72) Inventor: Yibing Li, San Francisco, CA (US)

(21) Appl. No.: 14/057,327

(22) Filed: Oct. 18, 2013

(51) Int. Cl. B05B 11/02; B05B 12/00

(52) U.S. Cl. CPC B05B 11/02; B05B 12/002
USPC 222/309

(57) ABSTRACT

A liquid dispensing device provides precise and adjustable control for dosing volumes. The device is adaptable when installed on bottles and tubes and works independently if equipped with its own container. A micrometer sitting on the outside cylinder of the device adjusts the position of a syringe to change the dispensing volume. The distal end of the cylinder holds the syringe. Inside the syringe, there are the upper and lower plungers. After adjusting the position of the syringe, the extended arm of the lower plunger is pushed all the way into the device so that the lower plunger emerges out of the open end of the syringe. This allows the liquid to flow into a pocket space partitioned by the upper plunger which is passively pushed to the position by the extended arm of lower plunger. After the liquid is filled, the extended arm of the lower plunger is pulled back towards the distal end. As the lower plunger retracts, a precise volume of liquid is trapped between upper and lower plungers in the syringe. This liquid is later dispelled through a dispensing outlet on the syringe wall by the upper and lower plungers.

### FIELD OF THE INVENTION

The present invention concerns the dosing and dispensing of liquid from a device. More specifically, this invention relates to a device that provides a precise and adjustable volume control for convenient liquid delivery.

### BACKGROUND OF THE INVENTION

Transfer of liquids is an ancient art and an integral part of human daily life. In the contemporary and modern age, efforts should be placed on improving this activity in terms of technique and process, for example quantity, efficiency, safety, accuracy, environmental soundness, and cost-effectiveness to meet many purposes in different circumstances.

For most purposes in society at large, transfer of liquids is still semi-quantitative or non-quantitative. However, in scientific research, accuracy and precision are critical; there are developed methods and techniques to perform volume-controlled transfer of liquid. Equipment and tools such as graduated cylinders, syringes, and graduated pipettes are widely used to transfer relatively large quantities of liquid. Pipettes (from 1 milliliter up to 20 milliliter) and pipetter tips (from 1 microliter up to 1 milliliter) are most commonly used when dealing with smaller volumes. Although they are efficient and accurate, they are not cost-effective or environmentally conscious because these pipettes and tips are usually only for one time use. A less popular device, a bottle top dispenser (U.S. Pat. No. 3,940,027), can efficiently transfer up to 10 ml liquid at any given time. However, it lacks convenience and accuracy, so it is not as commonly used as aforementioned laboratory equipment and devices. When dealing with large volumes (high-throughput), or when high accuracy is required, one can also use liquid handling robots that use automation to control the transfer of liquid. In this case, the liquid transfer becomes expensive.

With various shortcomings, the aforementioned methods, devices, and equipment have not become popular for general uses by the society at large. Nevertheless, in our century and beyond, accuracy will become an essential part of our daily life. That means a better way of liquid transfer for the general population will be more important than ever. For example, one might find it very useful to take the same amount of liquid nutrients or supplements everyday in order to control the calorie intake. It is also important for manufacturers and suppliers when producing food products. For the same reason, one might want to irrigate plants and vegetables with precise volume of water or nutrients periodically to control their growth. For mixing alcohol cocktails (U.S. Pat. No. 4,243,157), one might want to have an instrument with better consistency, more accuracy, and great flexibility to serve customers and to satisfy their individual taste in cocktails. For medicine and medications, some of the best therapeutic effect for certain medications are only achievable by dosing according to the body weight. Examples of such medications include, but are not limited to, chemotherapy medications, Aspirin, and Coumadin. The individualized dosing of anticoagulant medications, i.e. Aspirin and Coumadin, is important to tip the balance of blood coagulant system. The treatment effect as well as patient safety is better achieved by the adjustment of dosages based on the body weight. In this case, medicines in liquid formula do have advantage over medicines delivered by solid pills. Therefore, a liquid dosing device that provides accurate volume control will be essential in order to achieve the therapeutic goal. In cosmetics, such as hair dye, dye solutions can be aliquot exactly for individualized and repetitive use in order to achieve desired effects if such a device is part of the kit. Given these and many more potential uses, it is very desirable to have not only precise but also flexible liquid dispensers that are also easy to operate and efficient to use. The individual aliquots may range from very small volumes to quite large volumes, i.e. from less than one milliliter up to 10 to 20 milliliter.

### SUMMARY OF THE INVENTION

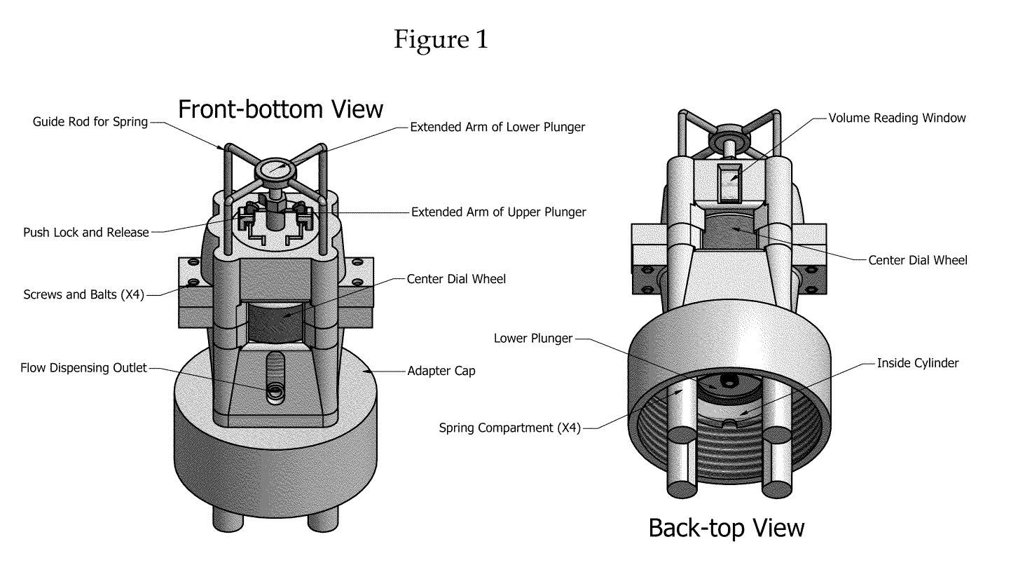

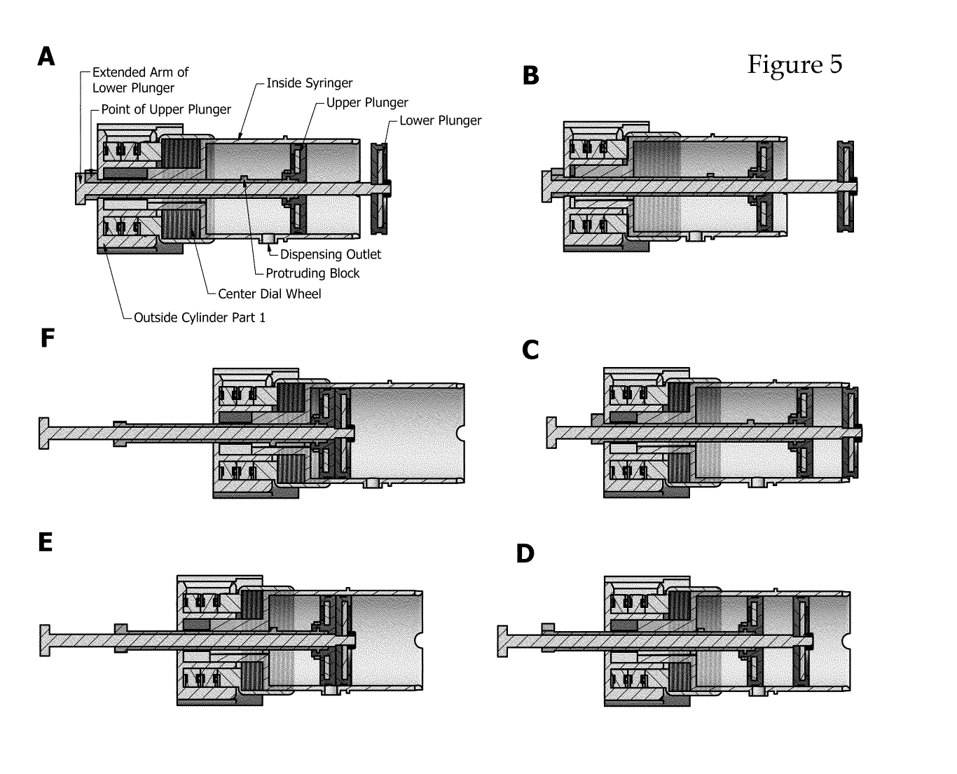

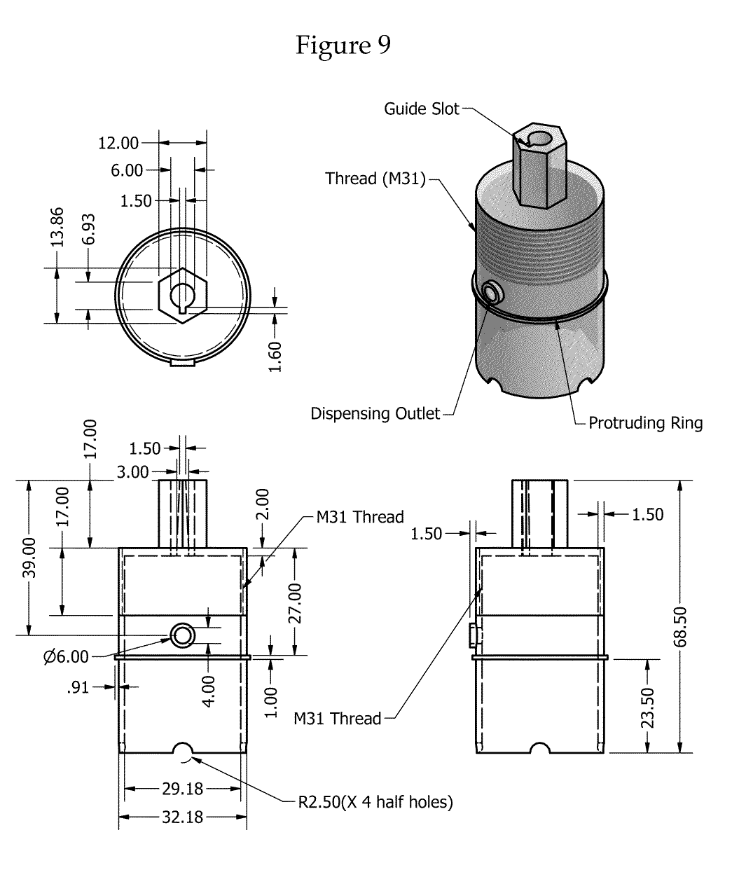

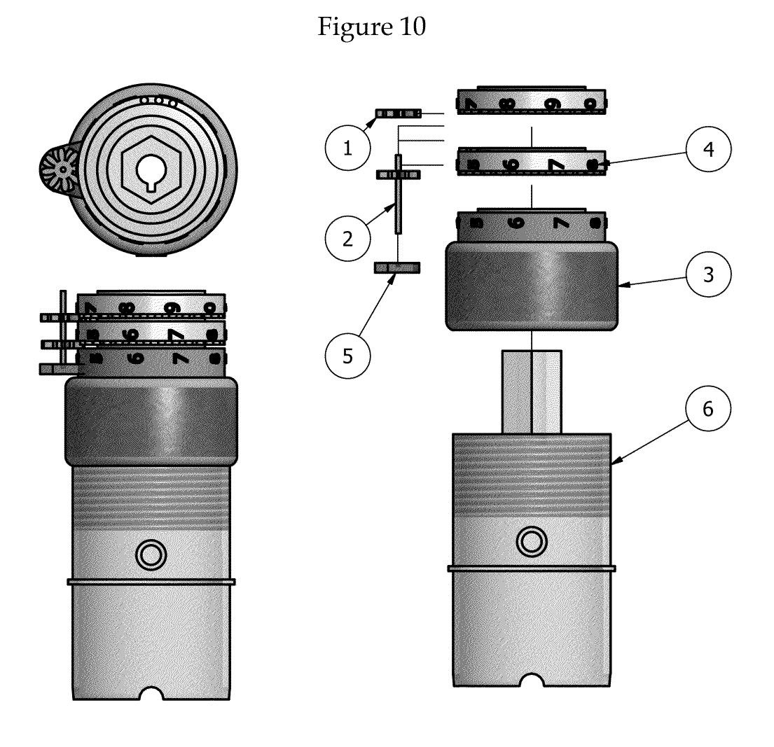

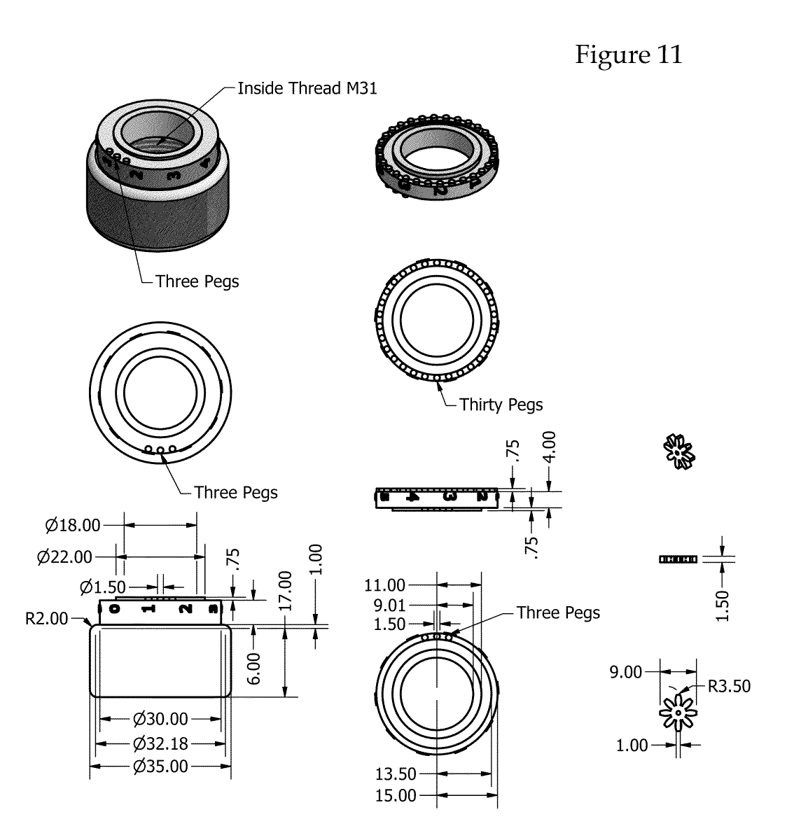

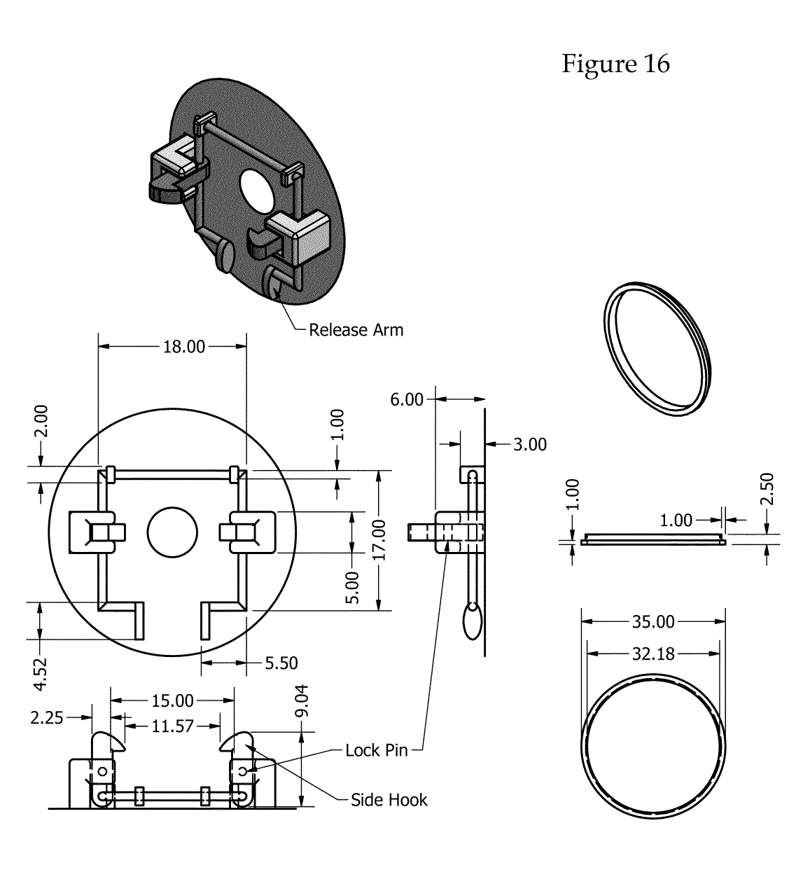

The current invention comprises of combining one syringe and two plungers, i.e. upper plunger and lower plunger, as key components at the inner compartment of the device. The upper plunger and lower plunger coordinate together to extract liquid from the syringe. There are several likely arrangements for these components to fit coordinately to achieve precise and adjustable liquid delivery. However, regardless of the nature of the structure or the manner in which these components are brought together, the fundamental principal remains the same, i.e. the position between syringe relative to other two components, i.e. the upper and lower plungers, is adjustable. In the current configuration, this adjustment is carried out by a dial wheel on the micrometer (named Center Dial Wheel, see FIG. 1, FIG. 10 and FIG. 11) placed on the syringe. As the dial wheel rotates, the syringe moves up and down along the axis of the device, i.e. moving between the distal or proximal ends, respectively, relative to the liquid reservoir. The syringe holds both the upper and lower plungers at the distal end. The proximal end of the syringe is in direct contact with the liquid inside reservoir. The arm of the upper plunger is hollow and allows the arm of the lower plunger to pass through it so that the upper plunger is further away while the lower plunger is closer to the liquid reservoir, relative to the upper plunger (FIG. 5). Because the extended arm of the upper plunger is short, the moving distance of the upper plunger is limited within the provided length of the syringe. Furthermore, because the extended arm of lower plunger is long, the lower plunger travels beyond the open end of the syringe (FIG. 5). On the syringe wall there is an opening near its distal end, named Dispensing Outlet (FIG. 1 and FIG. 9). Finally, the Syringe is partially covered by a cylinder at its distal portion that provides structural support. The cylinder also connects to a cap so that the device is adaptable and installable on bottles, containers, and tubes. The space between the Cylinder and Syringe is insulated by a Rubber Ring (FIG. 16) to prevent losing liquid from inside the reservoir to the outside.

To dispense specific volume from the device, an operator pushes the Extended Arm of Lower Plunger all the way into its proximal end and locks it in place. The operator then turns the Center Dial Wheel to adjust the position of the Syringe to set the dispensing volume. The dispensing volume is indicated by the Volume Reading Window (FIG. 1). The operator can also turn the Center Dial Wheel to designate the dispensing volume first and then push the Extended Arm into locked position. Since the Lower Plunger has a long arm, the plunger leaves the open end of the syringe and opens a pocket space to the flow. The pocket space, partitioned by the Upper Plunger in the syringe chamber, is then filled with the liquid (FIG. 5). The volume of the pocket is dependent on the position of the Syringe because the travel distance of the Upper Plunger is limited. When the Syringe is positioned at its proximal end, i.e. more inwards, the height of the pocket increases and the pocket's volume capacity increases (FIG. 5A). Then the desired volume of liquid fills the designated pocket capacity when the end of the Syringe opens. On the other hand, when the Syringe is positioned at its distal end, i.e. more outwards, the Upper Plunger protrudes into the Syringe chamber. As a result, the height of the pocket decreases and the volume capacity of the liquid decreases too (FIG. 5B). Next, the operator presses against the Release Arm on the device to activate the retreat of the Lower Plunger outwards. This is accomplished by an external force, e.g., by the elastic force of the springs or by direct pulling of the Extended Arm of Lower Plunger by the operator. As the Lower Plunger travels back it first seals the open end of the Syringe, and a preset volume of liquid is now trapped inside the syringe chamber (FIG. 5C). As the Lower Plunger travels further outwards, it pushes the Upper Plunger to move along with the Lower Plunger by the hydraulic pressure. The Upper Plunger stops movement when it reaches the Dispensing Outlet on the syringe wall. At this point, trapped liquid will be released by the force from the Lower Plunger. The dispensing process completes when two plungers contact inside the syringe.

### DETAILED DESCRIPTION OF THE DRAWINGS

FIG. 1: front-bottom view (left) and back-top view (right) of the device. The operator is at the front of the device, characterized by the Extended Arm of the Lower Plunger. The operator first presses the Extended Arm of the Lower Plunger into locked position, turns the Center Dial Wheel from the Volume Reading Window to adjust the dispensing volume, and then presses both Release Arms (FIG. 16) to activate the retreat of the Extended Arm of Lower Plunger. The retreat of the lower plunger stops when the exact amount of liquid is dissipated at the Flow Dispensing Outlet.

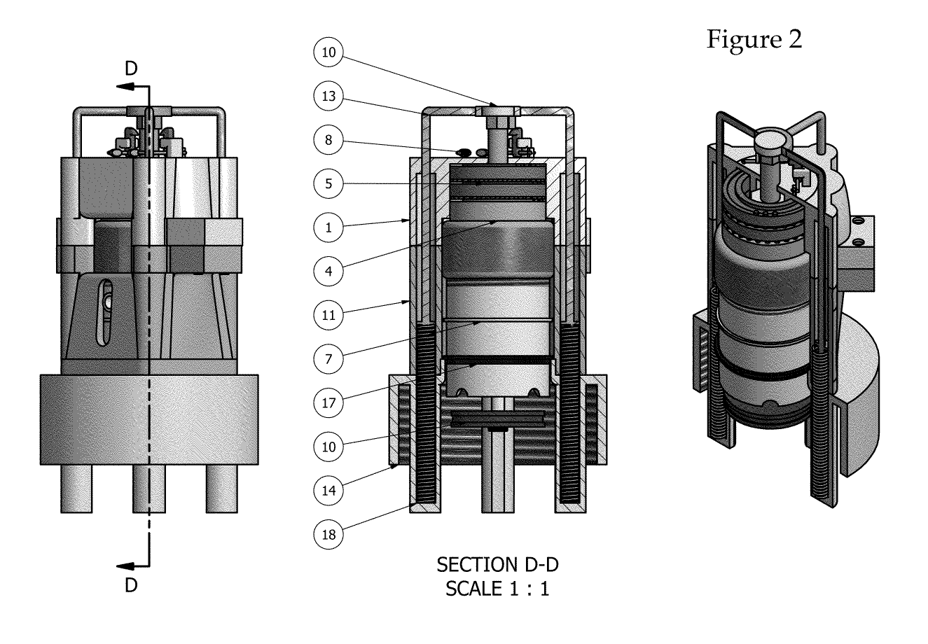

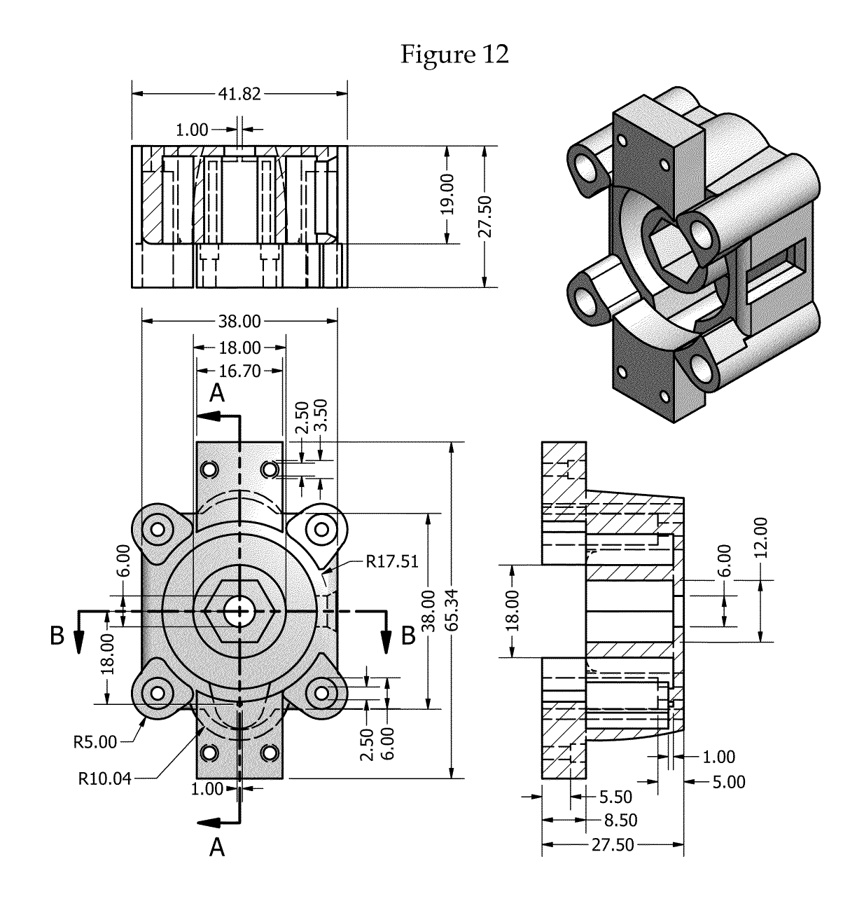

FIG. 2: low-right (left), sectional (center and right) views of the device. Only the Cover Cylinder that comprises of three separate parts (see FIGS. 12, 13 and 14) and the Guide Rod are sectioned; the remaining components are not sectioned. All components are identified by a balloon. From top to bottom: (10) Extended Arm of Lower Plunger; (13) Guide Rod; (8) Push, Lock, and Release; (5) Center Wheel (two pieces); (1) Cylinder Part 1; (4) Center Dial Wheel; (11) Cylinder Part 2; (7) Syringe; (17) Rubber Ring; (10) Lower Plunger; (14) Cylinder Part 3; and (18) Spring.

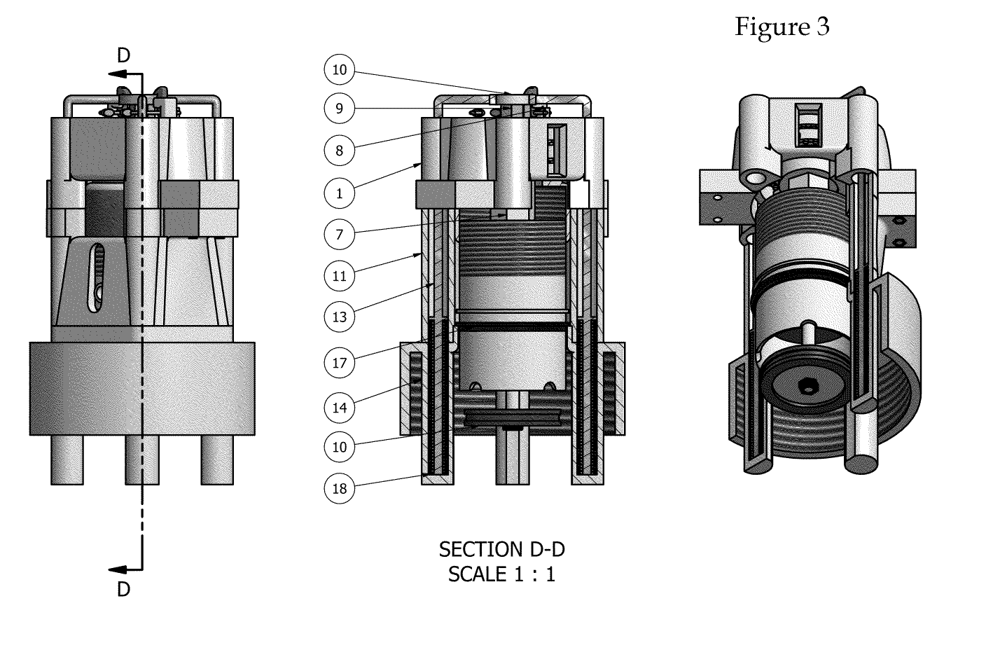

FIG. 3: low-right (left), sectional (center and right) views of the device. Only the Cylinder Part 2 and Part 3, Guide Rod, Center Dial Wheel and Spring are sectioned. The balloons from top to bottom are: (10) Extended Arm of Lower Plunger; (9) The Pointer on Upper Plunger; (8) Push Lock and Release; (1) Cylinder Part 1; (7) Syringe; (11) Cylinder Part 2; (13) Guide Rod; (17) Rubber Ring; (14) Cylinder Part 3; (10) Lower Plunger; and (18) Spring.

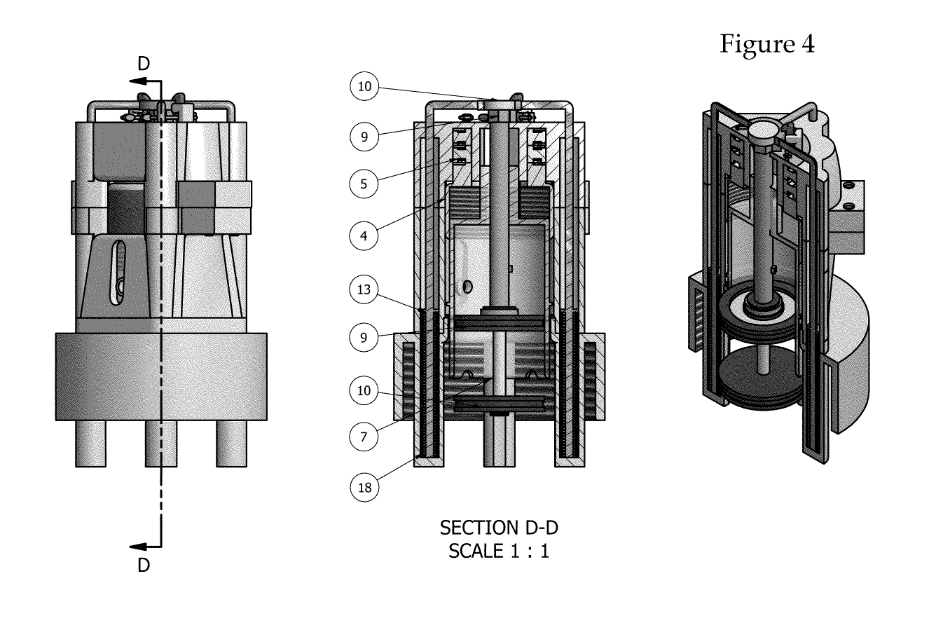

FIG. 4: low-right (left), sectional (center and right) views of the device. Only the Cylinder Part 1, 2 and 3, Guide Rod, Center Wheels, Center Dial Wheel, the Syringe, Rubber Ring and Spring are sectioned. The balloons from top to bottom: (10) Extended Arm of Lower Plunger; (9) The Pointer on Upper Plunger; (5) Center Wheel (two pieces); (4) Center Dial Wheel; (13) Guide Rod; (9) Upper Plunger; (10) Lower Plunger; (7) Syringe; and (18) Spring.

FIG. 5: schematic drawings illustrate the operating principle of the device. From the top left and clockwise are Panel A, B, C, D, E and F, respectively. Extended Arm of Lower Plunger, Pointer on Upper Plunger, Cylinder Part 1, Center Dial Wheel, Syringe, Protruding Block on Upper Plunger, Dispensing Outlet, and Upper and Lower Plungers are identified in Panel A. (A) The Extended Arm of the Lower Plunger is at locked position and the Syringe is positioned at its proximal end. The more inwards the syringe is positioned, the deeper the pocket is between the syringe and the upper plunger. (B) The Syringe is positioned at its distal end. The more outwards the syringe is positioned, the shallower the pocket is between the syringe and the upper plunger. (C) The Syringe is positioned at the intermediate stage. When the Extended Arm of the Lower Plunger is released from locked position and the lower plunger backtracks towards distal end, it forms the cap on the open end of the Syringe that contains a defined volume of liquid now trapped inside the pocket. As the Lower Plunger continues to backtrack, the Upper Plunger is forced to move along by the hydraulic pressure until the Upper Plunger reaches the Dispensing Outlet (D). Further retreat of the Lower Plunger dispels the liquid trapped inside the Syringe to the outside until the entire liquid is pushed out when the upper and lower plungers make contact (E). Normally the Upper Plunger will stop at vicinity of the Dispensing Outlet because the Protruding Block on the tube of the Upper Plunger prevents the upper plunger from moving further back (E). For certain applications, liquid can be continuously dispensed from the container. When the pointer on the Upper Plunger is aligned with the Dispensing Outlet, the Protruding Block on the tube of Upper Plunger tube will align with a Guide Slot inside the neck of the Syringe as well (FIG. 9). Under this condition (F), both upper and lower plungers can move further outwards. Then, both plungers will sit on the distal end of the Dispensing Outlet, allowing the continuous flow.

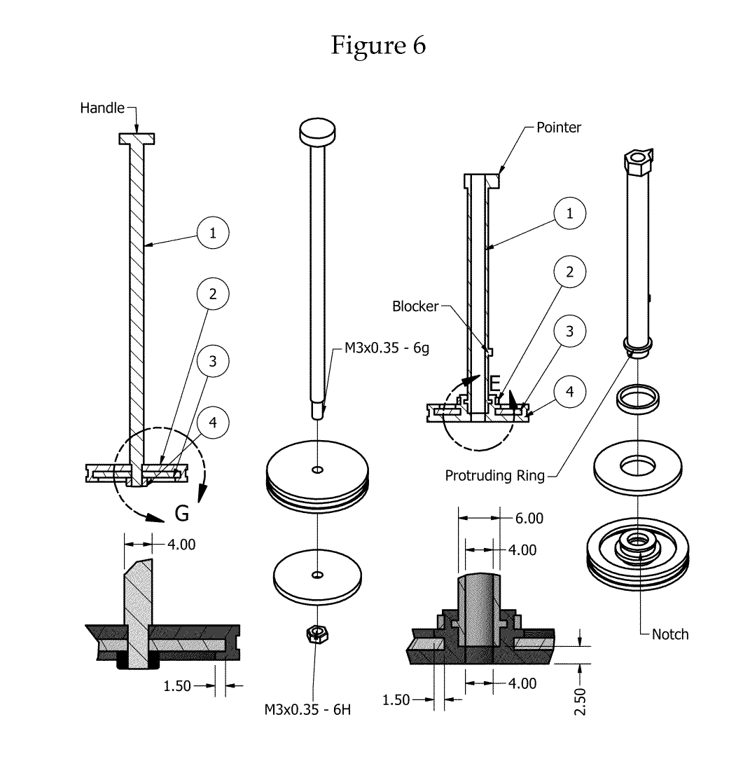

FIG. 6: diagrams for Lower Plunger assembly and Upper Plunger assembly. Columns from left to right: Column #1: sectional view (top) and detailed view (bottom) of Lower Plunger assembly. The balloons are used to identify following components: (1) Rod; (2) Rubber; (3) Disk; (4) Bolt. Column #2: Exploded view of the Lower Plunger assembly; Column #3: sectional (top) and detailed (bottom) views of Upper Plunger assembly. The balloons are designated as: (1) Tube; (2) Ring; (3) Disk; (4) Rubber. Note: both Pointer and Block on the upper plunger tube protruding in the same direction. Column #4: Exploded view of the Upper Plunger assembly.

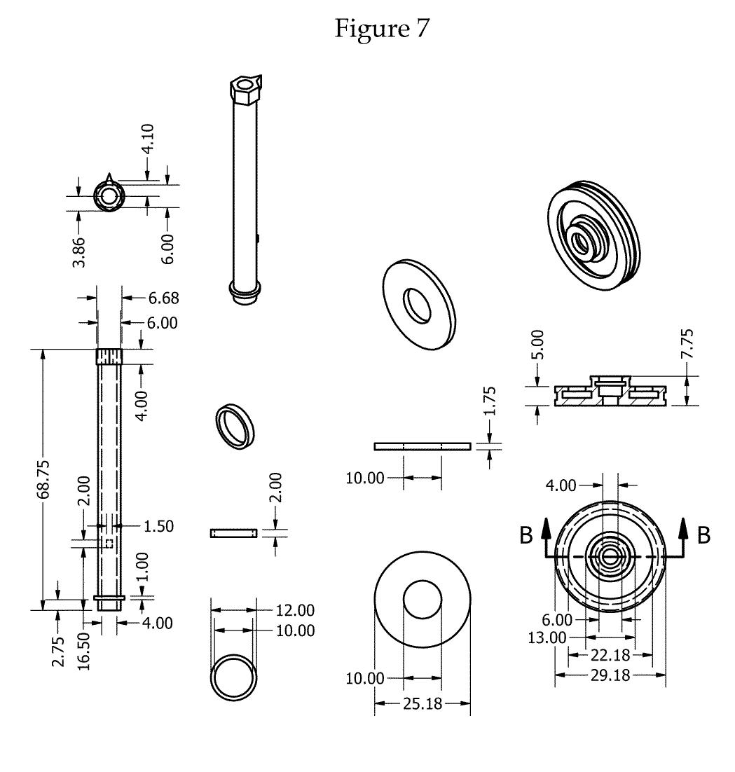

FIG. 7: schematic drawings of components of the Upper Plunger assembly. Columns from left to right: Column #1: (top to bottom) projected, front, and bottom views of the Upper Plunger tube; Column #2: projected, top, and front views of the upper plunger ring; Column #3: projected, top, and front views of the upper plunger disk; Column #4: projected, sectional, and front views of the upper plunger rubber.

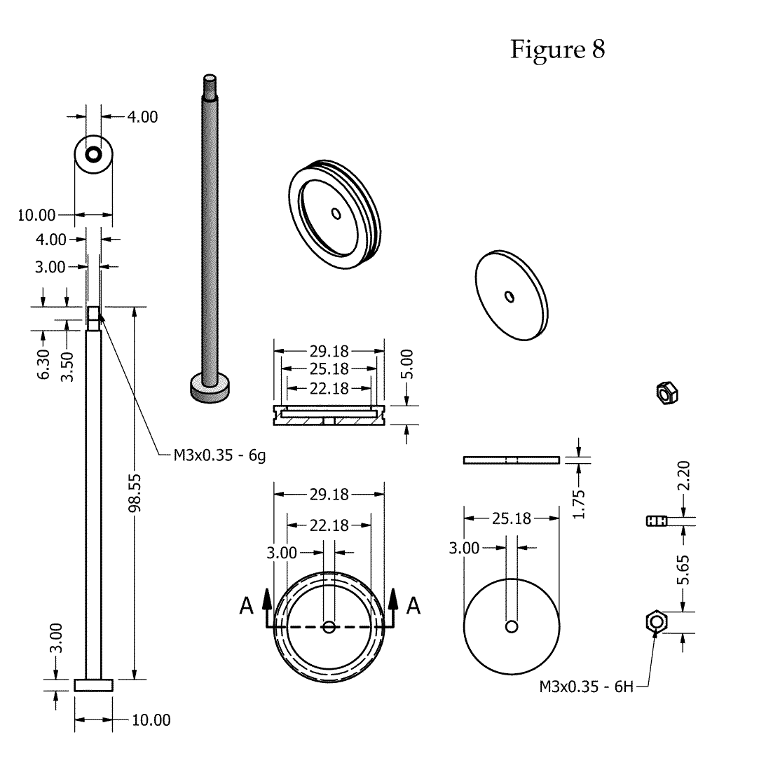

FIG. 8: schematic drawings of components of the Lower Plunger assembly. From left to right: Column #1: (top to bottom) projected, back, and top views of the lower plunger rod; column #2: projected, sectional, and back views of the lower plunger rubber; column #3: projected, top, and front views of the lower plunger disk; Column #4: projected, top, and front views of the lower plunger nut.

FIG. 9: schematic drawings of the Syringe. From top left and clockwise: front view, projected view, right view, and bottom view of the syringe, respectively. The Guide Slot, Thread (i.e. M31), Dispensing Outlet, and Protruding Ring are identified in the projected view. The guide slot is for the Protruding Block on the upper plunger tube to fit inside. The slot feature is also indicated by the dimensions in the front view section, i.e. 1.50 mm (width)×1.60 mm (depth) and in the bottom view section, i.e. ranged from 1.50 mm (top of the syringe) to 3.0 mm (bottom of the syringe neck). The Protruding Ring on the Syringe limits the range of the syringe to move to the proximity so that the syringe will not fall out from the Center Dial Wheel.

FIG. 10: Left panel: front (top) and bottom (bottom) views of the Syringe, Center Dial Wheel, Center Wheel, and Side Gear assembly. Right panel: exploded view of the assembly. All components are identified by a balloon: (1) Side Gears (X2); (2) Axel Rod; (3) Center Dial Wheel; (4) Center Wheels (X2); (5) Cover Piece; (6) Syringe.

FIG. 11: schematic drawings of Center Dial Wheel (left column), Center Wheels (middle column), and Side Gears (right column). Left column (top to bottom): projected view, front view, and bottom view of the Center Dial Wheel. Middle column: projected view, back view, top view, and front view of the Center Wheel. Left column: projected, top and front views of the Side Gear. Note: on the front view of both Center Dial Wheel and Center Wheel (bottom panel of middle column), there are only three pegs on the rim while on the back view of center wheel (second panel of middle column) there are thirty pegs on the rim.

FIG. 12: schematic drawings of Cylinder Part 1. There are four panels, and they are front view (lower-left), sectional view B (upper-left), projected view (upper-right), and sectional view A (lower-right) of the Cylinder part 1, respectively.

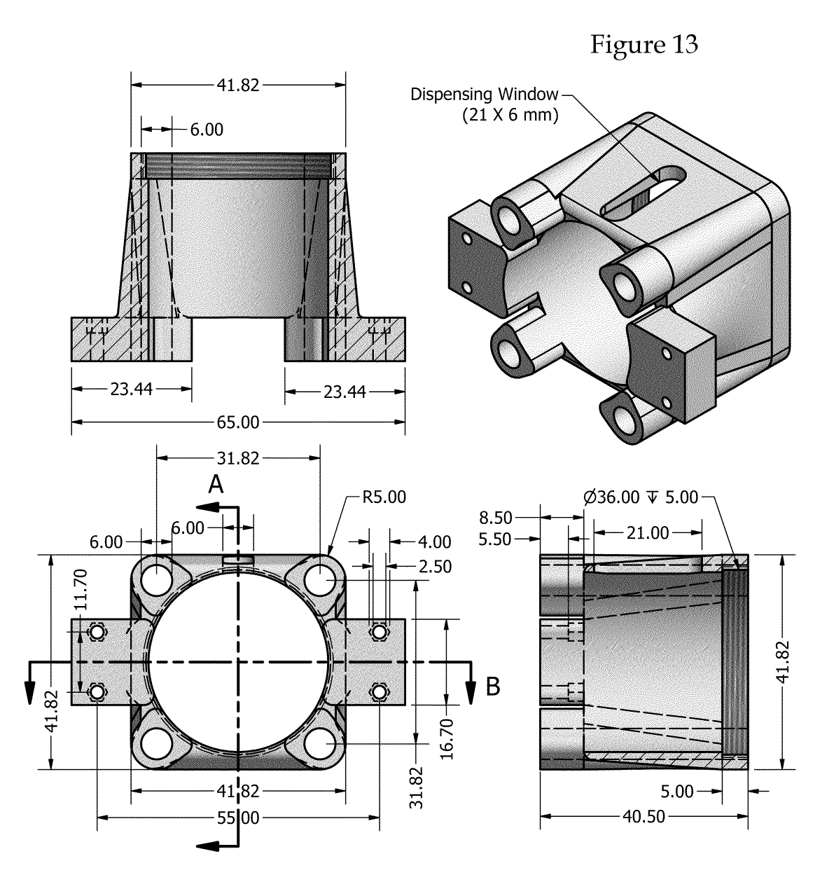

FIG. 13: schematic drawings of Cylinder Part 2. There are four panels, and they are front view (lower-left), sectional view B (upper-left), projected view (upper-right), and sectional view A (lower-right) of the Cylinder part 2, respectively.

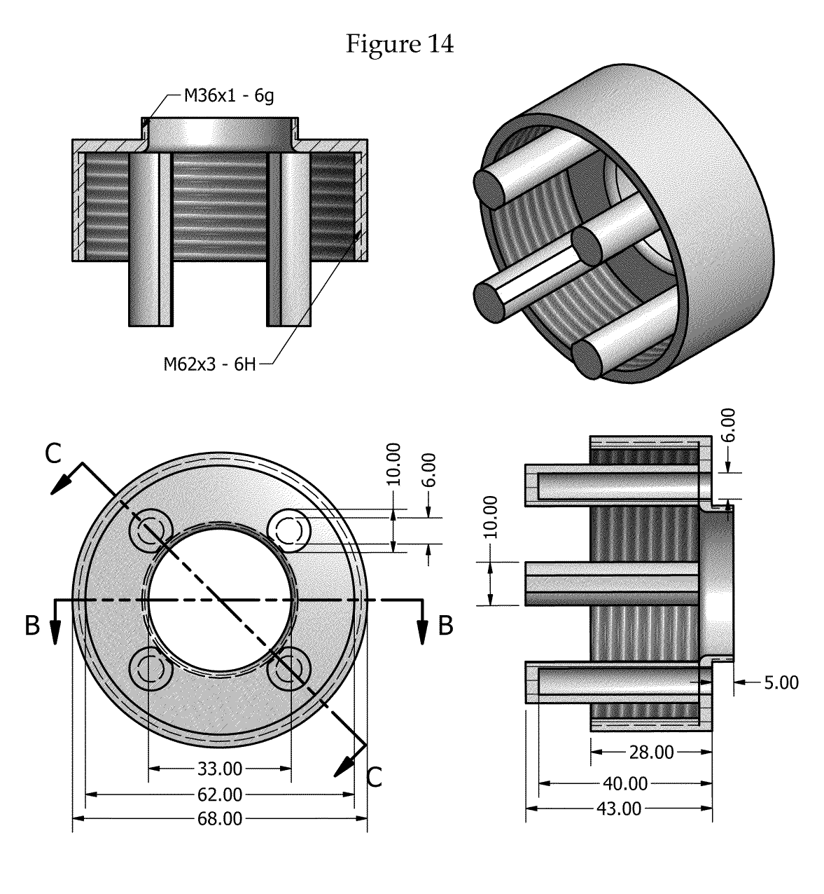

FIG. 14: schematic drawings of Cylinder Part 3. There are four panels, and they are back view (lower-left), sectional view B (upper-left), projected view (upper-right), and sectional view C (lower-right) of the Cylinder part 3, respectively.

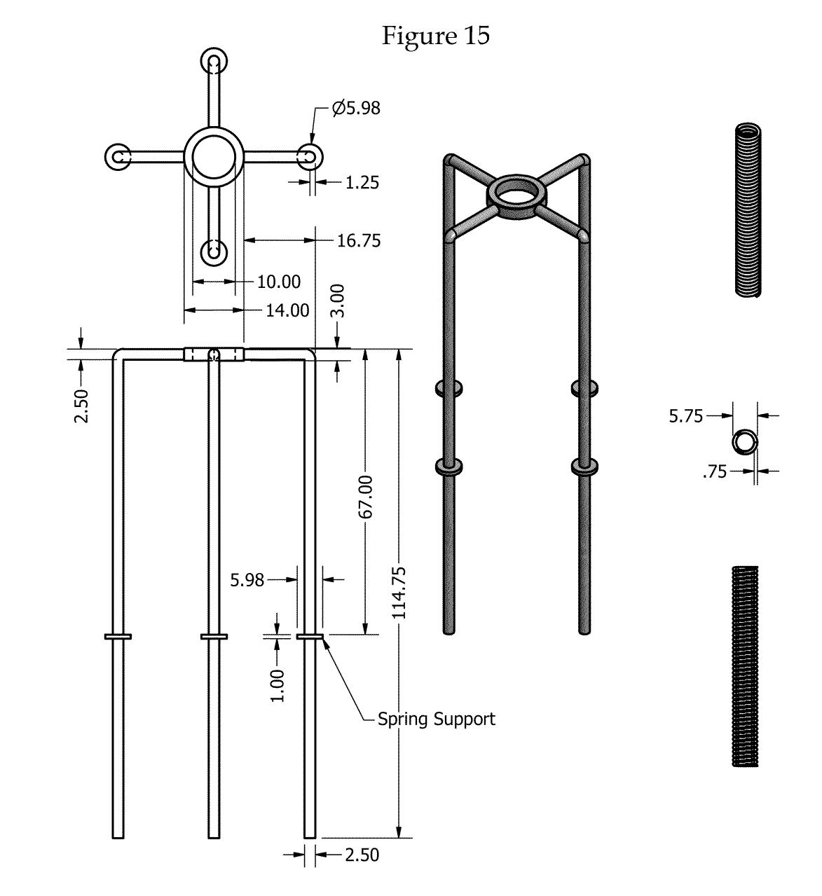

FIG. 15: schematic drawings of the Guide Rod (left column): front view (top) and bottom view (bottom), and projected view (middle column). Schematic drawings of the Spring (compressed) at right column: projected view (top), front view (middle), and bottom view (bottom).

FIG. 16: schematic drawings of the Push Lock and Release (left and middle columns) and the Rubber Ring (right column). Left column: The projected view of the Push Lock and Release (top). The release arms are identified. This is followed by front view and bottom view of the Push Lock and Release. The middle column is the side view of the Push Lock and Release. The right column is the Rubber Ring (from top to bottom): projected view, top view, and front view of the object.

### EXAMPLES

The current invention provides a novel liquid dispensing device characterized by one syringe and two plungers at its core structure to achieve precise and volume-adjustable liquid delivery. Combinations of these components, i.e. one syringe and two plungers, can have several arrangements. We have described one configuration in detail in which the Syringe is adjustable while the Upper Plunger is to move passively in and out following the lower plunger. The extended arm of Lower Plunger is pushed down and pulled up by external forces during operation as it is illustrated in FIG. 5.

There can be modifications from the current configuration. For example, the thread featured on the syringe can be replaced with discontinuous and parallel rings (like layers of repeats of small ridges and ditches). So that instead of turning a dial to adjust the syringe, one can simply position the syringe by just pushing the syringe down or pulling it up one step or a few steps at a time. Under this configuration, the dispensing volume is incrementally changed, e.g. every 0.2 milliliter increase or decrease, etc. Another possible modification is to move the thread featured on the outside of syringe chamber to the distal end of the syringe. This requires adding an extra segment distal to the hexagon neck. A dial wheel, similar to the Center Dial Wheel, which is constrained to the outside cylinder, can be used to adjust the position of the syringe. Although this configuration increases the dimension of the device, it might make some sense depending on the applications.

Based on the principle of one syringe and two plungers, there can be other combinations. For example, instead of driving Lower Plunger arm up and down while operating the device, one can push and pull the syringe to achieve liquid dispense. In this configuration, the lower plunger can be constrained inside the device to maintain a steady state during operation. The upper plunger is, however, adjustable relative to the syringe which is achievable by thread and dial wheel coupled on the upper plunger arm and syringe, respectively. When the relative position of the upper plunger and syringe is set, and the so called “pocket” is formed, the syringe is first pulled up (towards distal end, relative to liquid reservoirs) to open the pocket to the liquid. After flooding the space with liquid, the syringe is pushed down (towards proximal end) to dispense the liquid trapped between upper and lower plungers. Since the upper plunger is moving with the syringe it is passively and partially constrained and it will meet with the lower plunger inside syringe. As they are approaching each other, the liquid trapped inside syringe is dissipated by upper and lower plungers from the device.

What claimed is:

1. A liquid dispensing device comprising one syringe, two plungers in its core compartment wherein said syringe engages with one plunger to partition a pocket space to be filled with liquid from the open end of said syringe, and whereby converging between two plungers dissipates filled liquid inside said pocket space from a dispensing outlet on the wall of said syringe.

2. The adjustment of dispensing volume by said device of claim 1 is accomplished by the adjustment of the relative position of said plunger in partitioning said pocket space of claim 1 inside said syringe of claim 1, wherein the volume of said pocket space of claim 1 is determined by the distance from said plunger in partitioning said pocket space of claim 1 to said open end of said syringe of claim 1, and wherein the dispensing volume is the volume of said pocket space partitioned by said plunger of claim 1 inside said syringe of claim 1.

3. The liquid dispensing device of claim 1 comprising one syringe, one upper plunger, and one lower plunger in its core compartment wherein said upper plunger is situated inside said syringe at the vicinity of a dispensing outlet on the wall of said syringe, whereas said lower plunger at the start is positioned near the open end inside said syringe and with starting operation, said lower plunger moves towards and passes said open end of said syringe, and pushes said upper plunger to move away from said dispensing outlet towards said open end inside said syringe to partition a pocket space to be filled with liquid from said open end, and further said lower plunger and said syringe converges to seal said open end of said syringe after liquid fills said pocket space, and further said lower plunger enters and continuously converges with said syringe to push said upper plunger away from said open end up to said dispensing outlet by hydraulic pressure in the pocket of liquid trapped inside said syringe, and further said trapped liquid starts to be dissipated from said dispensing outlet after said upper plunger exposes said trapped liquid inside said syringe to said dispensing outlet, and finally all said trapped liquid is dissipated when said upper plunger and said lower plunger makes contact inside said syringe.

4. The pocket space partitioned by said upper plunger of claim 3 inside said syringe of claim 3 is adjusted by a featured thread on the external section of said upper plunger of claim 3 or said syringe of claim 3, and also by a dial wheel that runs on said thread on said upper plunger of claim 3 or said syringe of claim 3 to bring about changes of the relative position of said plunger of claim 3 inside said syringe of claim 3, and changes of said pocket space formed by said upper plunger of claim 3 and said syringe of claim 3.

5. The adjustment of pocket space formed by said upper plunger of claim 4 and said syringe of claim 4 is achieved by the featured thread on the external section of the syringe as it is exemplified in FIG. 9 and FIG. 10 of the current invention, and by the center dial wheel from a micrometer as it is exemplified in FIG. 10 and FIG. 11 of the current invention to run on said thread on the exterior of said syringe of claim 4 and to adjust said dispensing volume of claim 2 by said liquid dispensing device of claim 1.

6. The discharge of liquid from said liquid dispensing device of claim 3 is the result of the merge between said upper plunger of claim 3 and said lower plunger of claim 3, whereby the merge of said upper plunger of claim 3 and said lower plunger of claim 3 is powered by external force that exerts either on said upper plunger of claim 3 or on said lower plunger of claim 3, or both.

7. Said merge between said upper plunger of claim 6 and said lower plunger of claim 6 is driven by external force exerted on the extended arm of said lower plunger of claim 6, whereby the external force pulls the extended arm of said lower plunger of claim 6 away from the proximal position relative to the liquid reservoir to the distal position that is outward relative to said liquid reservoir of liquid dispensing device of claim 3.

8. Said external force of claim 7 is powered by springs as they are exemplified in FIG. 15 wherein said springs are constrained inside the spring compartment of said dispensing device of claim 3 and whereby springs exert their power through a guide rod as it is exemplified in FIG. 15 to push said extended arm of said lower plunger to the distal position and whereby, said lower plunger of claim 7 is pulled to merge with said upper plunger of claim 7 inside said syringe of claim 3.

9. Said syringe of claim 3 has the featured designs as it is exemplified in FIG. 9, wherein
A featured thread at the exterior which is run by said Center Dial Wheel as it is exemplified in FIG. 10 and FIG. 11 to slide said syringe of claim 1 along its axis, and
A neck with a diametric hexagon structure to prevent said syringe from rotary motion around its axis, and
A guide slot that allow the protruding block on the said upper plunger of claim 3 to slide in, and
A dispensing outlet for dissipation of liquid, and finally
A protruding ring to prevent said syringe from getting loose on said Center Dial Wheel by against the ring at cover cylinder part 2 and 3 as it is exemplified in FIG. 13 and FIG. 14.

10. Said upper plunger of claim 3 that has the featured designs as it is exemplified in FIG. 6 and FIG. 7, wherein
A protruding block on the tube of said upper plunger to restrict movement of said upper plunger of claim 3 inside said syringe of claim 3, and
A point structure at the distal end of the tube on said upper plunger to give the direction of extended block on said tube of said upper plunger of claim 3, and
A rubber plunger structure at the bottom of said upper plunger to prevent leak from the contact between lower plunger rod and upper plunger tube, and
A protruding ring at the proximal end of said tube of said upper plunger to prevent separation of the rubber plunger from said tube, and
A notch on said rubber plunger to host a circular ring as it is exemplified in FIG. 6 and FIG. 7 to reinforce the attachment of the said rubber plunger to the said tube in said upper plunger of claim 3.

11. The Push, Lock, and Release mechanism at said liquid dispensing device of claim 3 as it is exemplified in FIG. 1 and FIG. 16, wherein
A pair of side hooks to lock the extended arm of said lower plunger of claim 3 at proximal position, and
A pair of release arms to swing close in the bottom portion of said hooks and to swing open to the top portion of said hooks to release extended arm of said lower plunger of claim 3.
